(19) United States
(12) Patent Application Publication
(10) Pub. No.: US 2007/0208918 A1
(43) Pub. Date: Sep. 6, 2007

(54) Method and apparatus for providing virtual machine backup

(76) Inventors: Kenneth Harbin, Stroudsburg, PA (US); Ronald T. McKelvey, Morris Plains, NJ (US); Caleb Shay, Bushkill, PA (US)

Correspondence Address: Wendy W. Koba, Esq., PO Box 556, Springtown, PA, 18081, US

(21) Appl. No.: 11/712,129

(22) Filed: Feb. 28, 2007

Related U.S. Application Data
(60) Provisional application No. 60/777,840, filed on Mar. 1, 2006.

(51) Int. Cl. G06F 12/16

(52) U.S. Cl. 711/162

(57) ABSTRACT

A system and method for creating computer system backups, particularly well-suited for performing backups of virtual machines. The method starts by reading the current state of the machine, in blocks of a constant size, and creates a “FULL” index of block numbers and a hash value associated with the data within that block, while at the same time creating a FULL backup of the machine (the FULL backup then stored at an off-site target location). Once the FULL index map is defined, subsequent DELTA backups are created by reading the current state of the device in the same block fashion and generating updated hash values for each data block. The newly-generated hash values are compared against the values stored in the FULL index map. If the hash numbers for a particular block do not match, this is an indication that the data within that block has changed since the last FULL backup was created. Once all of the “changed” data blocks have been identified to form a DELTA backup, a communication connection is opened in the network and the DELTA backup is sent to the off-site target location.

### CROSS-REFERENCE TO RELATED APPLICATION

This application claims the benefit of U.S. Provisional Application No. 60/777,840, filed Mar. 1, 2006.

### TECHNICAL FIELD

The present invention relates to a method and apparatus for providing virtual machine backup and, more particularly, to the creation of sequential delta index maps that all relate back to a last-generated FULL index map such that a delta backup file may be used, in combination with the FULL backup file, to recover the virtual machine's data.

### BACKGROUND OF THE INVENTION

In IT architectures, large physical server infrastructures have become cost prohibitive, especially with respect to the management and maintenance of such structures. For these reasons, among others, IT managers have turned to the use of “virtual machines”. By using virtual machines, the server infrastructure is encapsulated within a virtual machine disk file. While the virtual machine has the look and feel of a real server, it is merely a file—no different than a word processing document, spreadsheet or a picture. Thus, to create a copy of the server one needs only to execute a “copy” of the file.

One critical area in which virtualization can bring immediate rewards is in allowing IT managers to create reliable backup and recovery strategies to prevent outages, regardless of whether the failure results from corruption, commonplace errors or large-scale disasters. Backup and recovery strategies are focused on keeping applications and data available and reducing downtime to a minimum, based on the needs of the business. In general, “backup and recovery” refers to a set of daily procedures for protecting IT systems from some form of failure. This failure can arise from many factors, ranging from hardware malfunction to malicious destruction, with the most common failure associated with the user who accidentally deletes or overwrites data.

Generally, backing up data on a virtual infrastructure does not appear to be very different from backing up data on a physical infrastructure. In purely physical environments, many organizations spend significant mounts of time trying to rebuild and recover operating systems to return to the point where the latest data can be restored. Virtual environments can be fully restored, if the appropriate processes are in place. A virtual machine may be backed up in its entirety, including both system and data. Many companies choose to backup entire images of virtual machines through detailed configuration and scripting, using Linux-based tools.

US Published Patent Application No. 2003/0056139 describes a prior art network-based data backup system that is applicable for use with virtual machines. The method includes creating a baseline copy of the data files that are to be archived. When the data is subsequently run through a backup process, the system checks for the presence of newly-added files by comparing the sort order of the present data files with the sort order of the baseline copy. Any newly-added files are then saved to the baseline copy. The system checks for any changes in existing files by comparing the hash numbers of the present data files with the hash numbers of the data files in the baseline copy. Any changed files are then merged into their corresponding data files in the baseline copy.

While this approach may be useful in some situations, it requires that the set of data files is reviewed in full at least twice each time a backup operation is being performed. Also, by reviewing the data on a file-by-file basis, the execution time of the system is relatively slow (e.g., some files that rarely change are reviewed as often as files that change daily). Further, by generating a hash of an entire file—when only a small segment has been changed—the entire file needs to be rewritten, instead of only the changed portion.

Thus, a need remains in the art for a network-based data backup and recovery system that is suitable for use with virtual machines and produces these backups with minimal time and space (file space) requirements.

### SUMMARY OF THE INVENTION

The needs remaining in the prior art are addressed by the present invention, which relates to a method and apparatus for providing virtual memory backup and, more particularly, to the creation of sequential delta index maps that all relate back to a last-generated FULL index map such that a delta backup file may be used, in combination with the FULL backup file, to recover the virtual machine's data.

In accordance with the present invention, the system first reads the disk (i.e., virtual machine or any other memory-containing device) and creates a FULL backup, including a FULL index map. The disk is read on a block-by-block basis, and the created index map includes an ordered pair of the “block number” and a hash of the block data. The block size and type of hash utilized are at the discretion of the backup system operator. Once the FULL index map is defined, subsequent DELTA backups are created by reading the current state of the device in the same block fashion and generating updated hash values for each data block. The newly-generated hash values are compared against the values stored in the FULL index map. If the hash numbers for a particular block do not match, this is an indication that the data within that block has changed since the last FULL backup was created. Once all of the “changed” data blocks have been identified to form a DELTA backup, a communication connection is opened in the network to the off-site target location and the changes are transmitted during a single session, and may be compressed and/or encrypted prior to transmission. Indeed, on-site and off-site backups may be created simultaneously. The transmission of all changes as a continuous transmission is considered an advance over the prior art, which would first “open” a communication session to the target location and then transmit the deltas as they were discovered. If a sufficient period of time elapsed between the transmission of changed data blocks (a commonplace occurrence where there are few data changes), the session had the likelihood of being dropped for lack of activity.

In one embodiment of the present invention, the DELTA backup is created “on the fly”, comparing the currently-generated hash value with the stored value for that same block number in the FULL index map. If the hash values match, that block is ignored and the process moves on to generate the hash value for the next block. Otherwise, the changed block is stored in a DELTA backup and indexed within a DELTA index map. In an alternative embodiment, a complete DELTA index map is first created for the current state of the device. The DELTA and FULL index maps are compared to side-to-side to flag those blocks that have changed since the FULL was created. In either case, only the changed data blocks are retained in the DELTA backup and transmitted to the target location.

In accordance with the present invention, an updated DELTA backup is created on a regular basis (e.g., once a day), where the “current” hash values for each block are compared, in sequence, against the values stored in the FULL index map. As time goes on, therefore, DELTA backups grow larger and larger, since each DELTA includes a cumulative listing of all incremental changes. In one embodiment of the present invention, the size of the DELTA backup can be monitored and once the size exceeds a predetermined threshold, a new FULL index map is created, even if the default time period associated with the creation of DELTAs (e.g., 20 days) has not been reached.

The system of the present invention can be multi-threaded, depending on the host, providing backup of different virtual machines at the same time. The backup and recovery system is self-extracting, incorporating executable commands within the file.

Other and further implementations and aspects of the present invention will become apparent during the course of the following description and by reference to the accompanying drawings.

### BRIEF DESCRIPTION OF THE DRAWINGS

Referring now to the drawings,

FIG. 1 is a simplified block diagram of an architecture for implementing the backup/recovery system of the present invention;

FIG. 2 is a flowchart illustrating an exemplary process for generating an initial “FULL” index map for a device (e.g., virtual machine) that is going through a backup process;

FIG. 3 is a flowchart illustrating an exemplary process for generating an incremental DELTA backup and associated DELTA index map in accordance with the process of the present invention; and

FIG. 4 is an illustration of a set of three different DELTA backups associated with the same FULL index map, each generated on a separate day.

### DETAILED DESCRIPTION

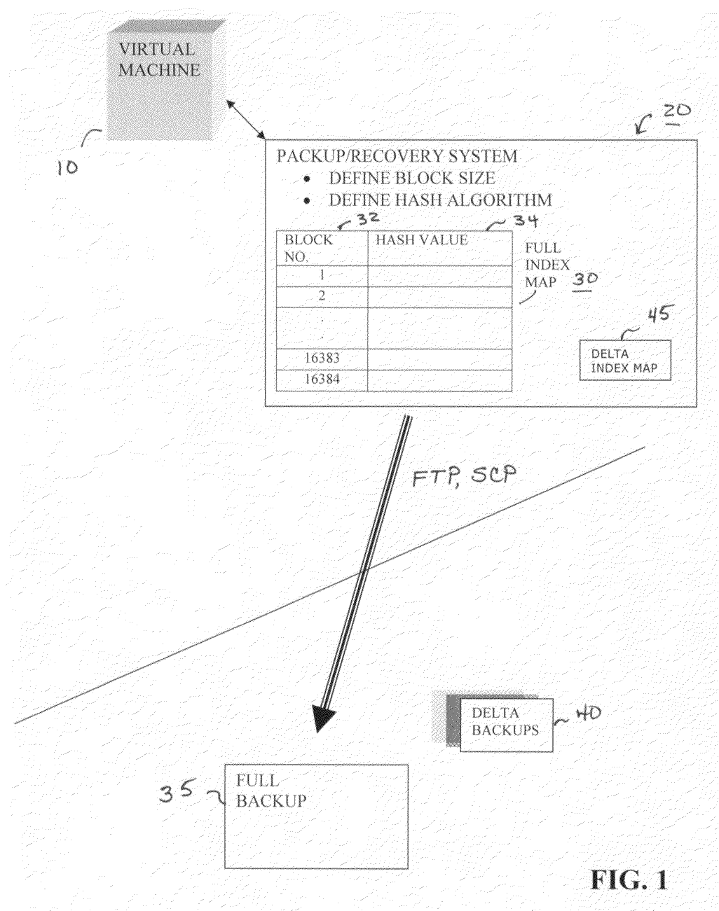

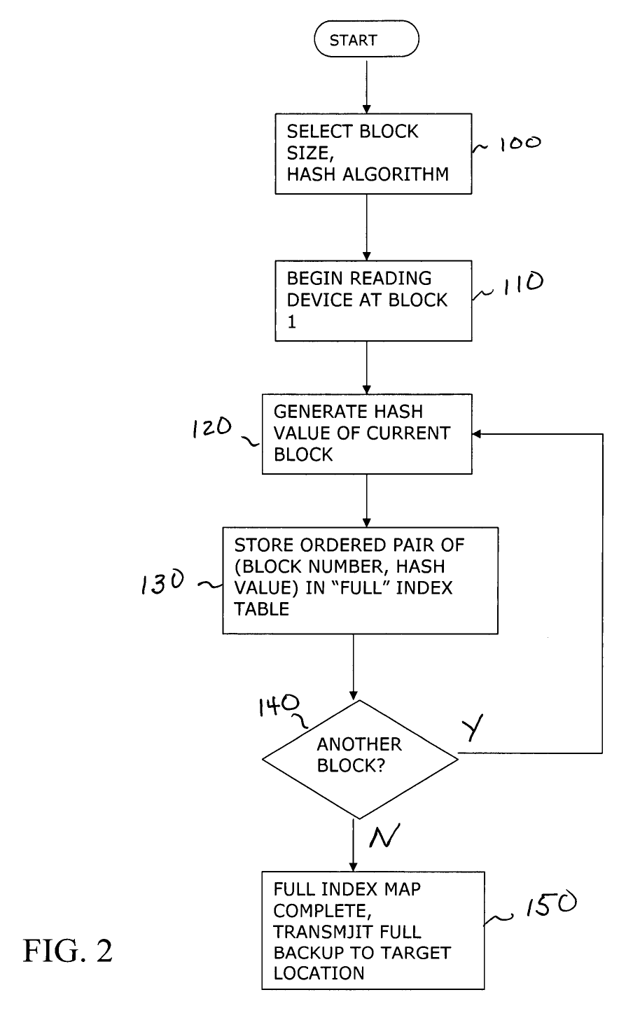

FIG. 1 includes a diagram illustrating the creation of an initial FULL backup and FULL index map of exemplary virtual machine 10, where the flowchart of FIG. 2 contains an exemplary process flow associated specifically with the creation of the index map in accordance with the methodology of the present invention. Shown in association with VM 10 is backup/recovery system 20 of the present invention. A FULL index map 30 that is generated by interactions between VM 10 and system 20 is also shown in FIG. 1, where the FULL backup 35 created by system 20 is stored in a target location 37. As mentioned above, target location 37 is preferably an off-site location, but is not so limited in the broadest application of the present invention. While system 20 is illustrated as interacting with a single VM 10, it is to be understood that the process of the present invention is applicable to utilization with a plurality of virtual machines, and is capable of creating separate indices at the same time (multi-threaded processing).

As mentioned above, a significant aspect of the present invention is the creation of an initial FULL index map, such as map 30 of FIG. 1. Map 30 is shown as including a listing of block numbers in field 32, from “1” until the last block of data in VM 10, in this example defined as, “block 16384”. Field 34 in map 30 includes the encrypted hash value generated from the data included in the current block. Referring to FIG. 2, the process begins (step 100) with the selection of: (1) a “block” size to be used when reading through VM 10; and (2) a hash algorithm to be used to generate a hash value of the current block being read. In a preferred embodiment of the invention, a block size of 256 k bytes has been found acceptable, with the use of the MD5 hash to generate the hexadecimal equivalent of the block being read. System 20 reads the first block of data in VM 10 (step 110), generates the associated MD5 hash value (step 120) and stores the results of steps 110 and 120 as an ordered pair in table 30 (step 130). The process continues at step 140 with performing a check to see if there is another block in VM 10. If no further blocks are found, the process ends (step 150) and FULL index map 30 is defined as “complete”, with FULL backup 35 then transmitted to target location 37.

Alternatively, if further blocks are found, the process returns to step 120 to generate the hash value for this next block, then storing the ordered pair in the index map. The process then continues in the same fashion until each block of data within VM 10 has been read and indexed, forming both FULL index map 30 and FULL backup 35.

Once FULL index map 30 has been created for VM 10, backup/recovery system 20 will be utilized to periodically access VM 10 and create a DELTA backup and new index map, based upon the current state of VM 10. The “new” index map (referred to as a DELTA index map) is compared to FULL index map 30, where changes are noted (i.e., changes in the hash value of certain blocks), stored in a DELTA backup 40 and ultimately transmitted to target location 37. As will be explained in detail below, the process of creating DELTA backup 40, DELTA index map 45 and comparing this index map against the FULL index map may be accomplished in at least two different ways.

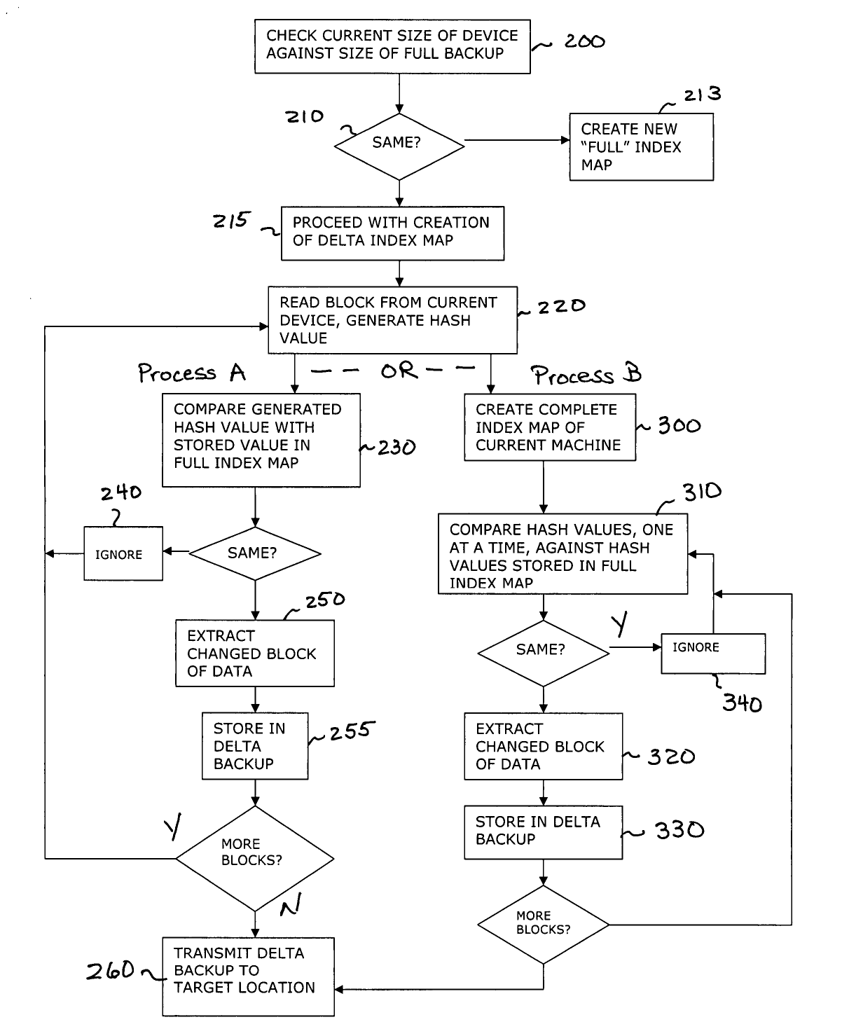

Preferably, prior to initiating the creation of a DELTA backup, the size of the drive associated with FULL index map 30 is compared against the current size of VM 10. If the sizes are different (indicating that disks were added or deleted in the “virtual”), the DELTA creation process is suspended, and a new FULL index map 30 and FULL backup 35 are generated (step 213). This “size check” is illustrated in steps 200 and 210 in the DELTA creation flowchart of FIG. 3. Presuming that the size of VM 10 has not changed, the process of creating a DELTA backup will be initiated (step 215). As shown at step 220 of FIG. 3, the DELTA backup process begins with reading the “current” state of VM 10 one block at a time, using the same block size as used to create FULL index map 30. Again, the hash value for the current block is calculated, using the same hash algorithm.

In a first embodiment of the present invention, as shown in process flow A in FIG. 3, an “on the fly” DELTA backup 40 and index map 45 are created by comparing the hash value of block X in current VM 10 (starting with X=1 and incrementing thereafter) to the stored hash value for block X in FULL index map 30 (step 230). If the values are the same, there has been no change in the data within block X, and the delta creation process ignores block X (step 240). The process then continues by moving on to block X+1 (step 220), generating its hash value and comparing this value against the hash value stored for block X+1 in FULL index map 30. Presuming in this case that the hash values are different, the process proceeds to step 250 and extracts the changed block of data and stores the changed data in DELTA backup 40 (the changed data block may be compressed and/or encrypted to provide increased security/efficiency). The block number and updated hash value are stored in DELTA index map 45 (step 255).

Once this update to data block X+1 has been indexed and stored, the process checks to see of any blocks are remaining and, if so, moves on to block X+2 (step 220) and continues in a similar fashion. Once the last block has been reached, a communication session is created with target location 37 (step 260) and the information in DELTA backup 40 is transmitted in a single, continuous data stream. As mentioned above, such a continuous transmission is considered to be faster and more efficient that prior art delta backup systems, where a session is first opened and then the delta blocks are transmitted as they are discovered. DELTA backup 40 may be transmitted using any desired arrangement, such as FTP, or may use SCP for higher security applications. Alternatively, the backups may be transmitted to a direct-attached storage device such as disk, tape, CD, DVD, USB including, but not limited to, any other permanent or removable media or device (not shown).

In a second embodiment of the present invention, shown as process flow B in FIG. 3, a complete index map 45 of the current snapshot of the device is first created (step 300). Once the entire DELTA index map has been formed, each block 1, . . . , X, . . . 16384 is interrogated and its hash value compared against the hash value in FULL index map 30 (step 310). For any blocks where the hash value has changed, the block is extracted from the current state of VM 10 (step 320) and stored in DELTA backup 40 (step 330). A check is then made to see if any more blocks are present and, if so, returns to step 310 to check the next. Blocks that have the same hash value are ignored (step 340) and process flow B returns to step 310. Ultimately, when the complete DELTA index map 45 has been checked, DELTA backup 40 is transmitted to target location 37 (step 260).

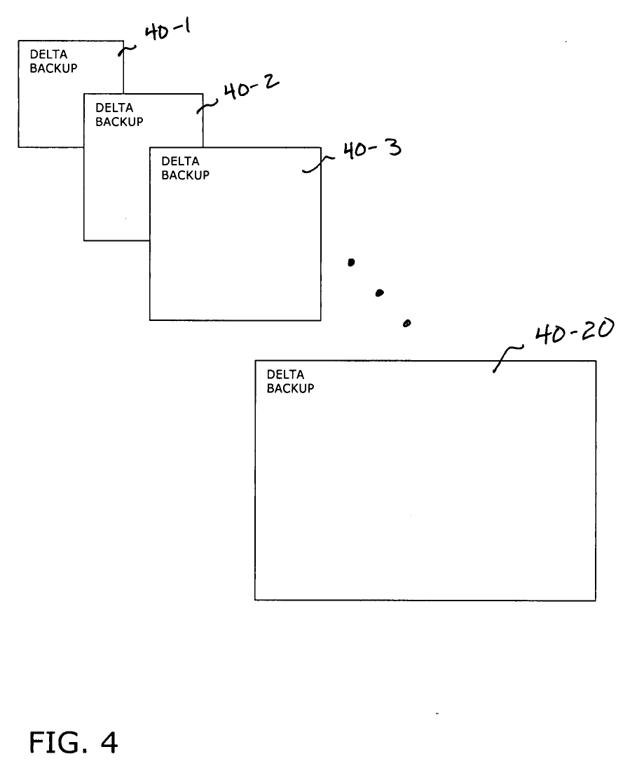

In most backup/recovery systems, a new DELTA backup will be created periodically. Conventionally, a backup is made at night when there is little, if any, activity on VM 10. Presuming that system 20 of the present invention is configured to create a new DELTA backup every 24 hours for twenty days in a row, a plurality of twenty DELTA backups 40-1, 40-2, . . . , 40-20 will be created, as shown in FIG. 4. In accordance with the present invention, the DELTA backups 40 are then available for use, in conjunction with FULL backup 35, to recover the data of VM 10 should it experience a failure.

Since the plurality of DELTA backups 40 are each created by performing a comparison against the FULL index map 30 created on the first day of the backup period, DELTA backups 40 will grow larger over time. The following is an example backup of a Novell NetWare 6 server. Its VM file was 100 GB in size, and the associated FULL backup 35 was compressed to 10 GB. The DELTA backups 40 increased in size from 1.2 GB to 4 GB, as shown below:

### 10G 2007.02.27-Netware_{—}6.5.564da662-67c3-4ed198721d9d2.FULL/00-Netware_{—}6.5.vmdk.gz-070227-2001.phd

### 1.2G ./2007.02.07-Netware_{—}6.5.564da662-67c3-4ed198721d9d2.DELTA/00-Netware_{—}6.5.vmdk.gz-070227-2001.phd

### 4G ./2007.02.07-Netware_{—}6.5.564da662-67c3-4ed198721 d9d2.DELTA/00-Netware_{—}6.5.vmdk.gz-070227-2001.phd

In this case, server1 took almost one hour to generate the FULL backup, for an effective speed of 100 GB/hour. Each DELTA backup was completed in less than twenty-five minutes. In general, each DELTA has a size in the range of 1-20% of the original file size, resulting in a significant reduction in the storage requirements for daily backups.

In order to restore VM 10, backup/recovery system 20 accesses FULL backup 35, and begins to read each block. When a block number associated with changed data is reached, the appropriate DELTA backup is used to insert the changed block(s) directly into the stream of data as it is being read out of FULL backup 35.

Numerous variations and modifications will become apparent to those skilled in the art once the above disclosure is fully appreciated. It is intended that the following claims be interpreted to embrace all such variations and modifications.

What is claimed is:

1. A method of creating a backup of a plurality of files forming a virtual machine, the method comprising the steps of:
a) creating a complete backup copy of the virtual machine (FULL backup) and storing the FULL backup in a separate target location;
b) creating a block-based index map of the FULL backup, the FULL index map including a listing of block numbers and a hash value of each block; and
c) performing a backup session after a predetermined period of time by generating updated hash values each block of data within the virtual machine, comparing the updated hash values with those stored in the FULL index map, storing changed hash values and associated block numbers in a DELTA index map and creating a DELTA backup comprising each changed block of data.

2. The method as defined in claim 1, wherein prior to performing step c), performing the step of checking the size of the virtual machine against the size of the FULL backup, and returning to step a) if the sizes are different, otherwise, continuing with the process of step c).

3. The method as defined in claim 1 wherein a predefined block size and predefined hash algorithm are used to form the FULL index map of step b) and the DELTA index map of step c).

4. The method as defined in claim 3 wherein the predefined block size is 256 k byte.

5. The method as defined in claim 3 wherein the predefined hash algorithm is the MD5 algorithm.

6. The method as defined in claim 3 wherein the predefined hash algorithm comprises a proprietary algorithm.

7. The method as defined in claim 1, wherein the method further comprises the step of:
d1) transporting the created DELTA backup to the target location storing the FULL backup.

8. The method as defined in claim 1, wherein the method further comprises the steps of:
d2) transporting the created DELTA backup to the target location storing the FULL backup;
e) waiting a predetermined period of time;
f) returning to step c) to create a new DELTA backup; and returning to step d2).

9. The method as defined in claim 8, wherein the method further comprises the step of:
g) repeating steps e) and f) for a predetermined number of days, then
h) generating a new FULL backup and FULL index map.

10. The method as defined in claim 8 wherein the predetermined period of time is twenty-four hours.

11. The method as defined in claim 9 wherein the predetermined number of days is thirty days.

12. The method as defined in claim 1, wherein in performing step c) the following steps are performed:
1) reading a first block of data within the virtual machine;
2) generating a hash value of the block of data;
3) comparing the hash value generated in step 2) to the stored hash value in the FULL index map; and
4) if the hash values are the same, ignoring the current block of data and moving to step 6), otherwise
5) storing the changed data block in the DELTA backup and the current block number and hash value in the DELTA index map;
6) incrementing the block number and determining if another block of data is present in the virtual machine; and
7) if not, the process is completed, otherwise 8) returning to step 2).

13. The method as defined in claim 1, wherein in performing step c) the following steps are performed:
1) creating a full index map of the updated virtual machine;
2) comparing the hash value of each entry in the full index map created in step 1) to the associated entry in the FULL index map created in step b); and
3) if the hash values are the same, moving on to read the next hash value, otherwise
4) storing the changed data block in the DELTA backup and storing the current block number and hash value in the DELTA index map;
5) repeating the process of steps 2)-4) until each block has been compared; and
6) transmitting the completed DELTA backup to the target location.
